(19) United States
(12) Patent Application Publication
(10) Pub. No.: US 2016/0050175 A1
(43) Pub. Date: Feb. 18, 2016

(54) ALERTING A MEETING PARTICIPANT TO REJOIN A VIDEOCONFERENCE

(71) Applicant: Cisco Technology, Inc., San Jose, CA (US)

(72) Inventors: Zaigham Riaz Chaudhry, Suzhou (CN); Shane Lin, Suzhou (CN); Edward Wang, Suzhou (CN); Leo Wang, Suzhou (CN); Goey Xiao, Suzhou (CN)

(21) Appl. No.: 14/461,775

(22) Filed: Aug. 18, 2014

(51) Int. Cl. H04L 12/58; H04L 29/06

(52) U.S. Cl. CPC H04L 51/24; H04L 51/02; H04L 65/1096

(57) ABSTRACT

Meeting participants of a videoconference can be enabled to alert the other meeting participants that they are going to be away from or inattentive during a portion of the videoconference. For example, each meeting participant can be presented with a user interface element, such as a button, that the meeting participant can select to alert the other meeting participants that the meeting participant will be away or inattentive during a portion of the videoconference. The meeting participants can also be enabled to alert an away meeting participant to rejoin the videoconference. For example, meeting participants can be presented with a user interface element, such as a button, that can be selected to send an alert to an away meeting participant to rejoin the teleconference. A meeting participant can also select to be alerted when a specified alert trigger occurs, such as when a specified word or phrase is used.

### TECHNICAL FIELD

The present disclosure pertains to videoconferences, and more specifically pertains to alerting an away meeting participant to rejoin the videoconference.

### BACKGROUND

Videoconferences allow participants to meet from multiple locations through use of their computing devices. For example, meeting participants from multiple geographic locations can join the videoconference and communicate with each other to discuss issues, share ideas, etc. While videoconferences provide the ability for meeting participants to participate from various locations, having the meeting participants so far apart can make it difficult to know the exact whereabouts of each meeting participant during the meeting. For example, during a conventional meeting, the meeting participants can see when a meeting participant has left the room. Likewise, when a meeting participant is not concentrating on the meeting, the other participants can easily get the meeting participants attention if needed. Videoconferences, in contrast, do not provide the close proximity between meeting participants to allow for such simple communication. Accordingly, improvements are needed.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 shows an example configuration of devices and a network;

FIG. 2 shows an example method embodiment of alerting an away meeting participant to rejoin a videoconference;

FIG. 3 shown an example method embodiment of alerting an away meeting participant to rejoin a videoconference upon an alert trigger occurring;

FIGS. 4A-4C show example embodiments of a videoconference interface presented to a meeting participant; and

FIGS. 5A and 5B show example possible system embodiments

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

The disclosed technology addresses the need in the art for alerting an away meeting participant to rejoin a videoconference. Meeting participants of a videoconference can be enabled to alert the other meeting participants that they are going to be away from or inattentive during a portion of the videoconference. For example, each meeting participant can be presented with a user interface element, such as a button, that the meeting participant can select to alert the other meeting participants that the meeting participant will be away or inattentive during a portion of the videoconference.

The meeting participants can also be enabled to alert an away meeting participant to rejoin the videoconference. For example, meeting participants can be presented with a user interface element, such as a button, that can be selected to send an alert to an away meeting participant to rejoin the teleconference.

In some embodiments, a meeting participant can select to be alerted when a specified alert trigger occurs. For example, the a meeting participant may wish to perform other tasks until a portion of the meeting that is relevant to the meeting participant. The meeting participant can select an alert trigger that indicates that the relevant portion of the meeting is approaching. For example, the meeting participant can select the an alert trigger such as a specified word or phrase being used during the meeting. Upon the specified word or phrase being used, an alert message can be transmitted to the meeting participant alerting the meeting participant that the alert trigger has occurred. The meeting participant can then rejoin the videoconference.

### Example Embodiments

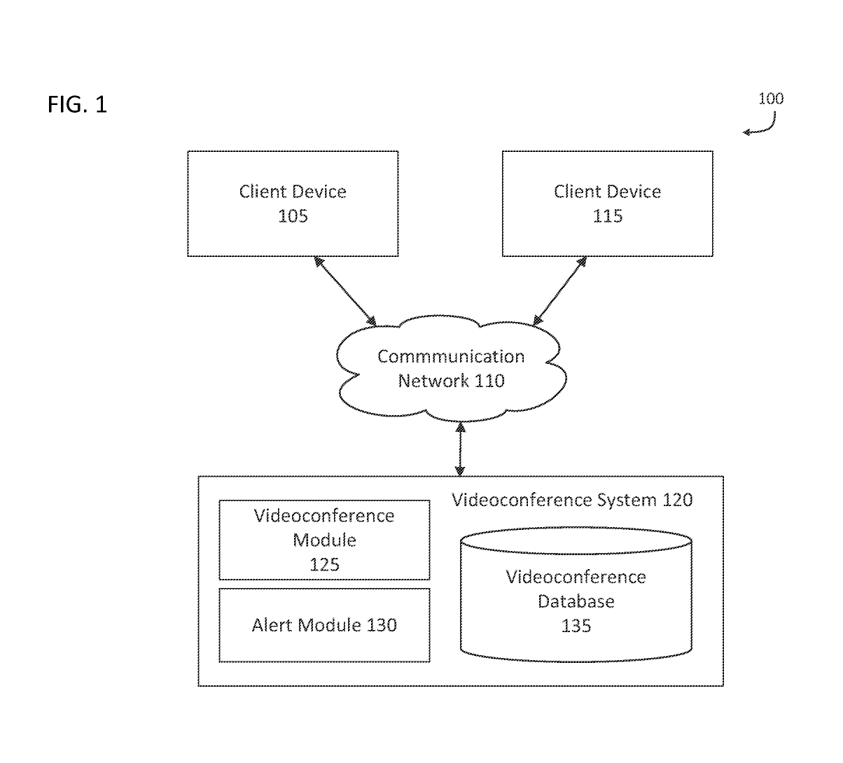

FIG. 1 shows an example system configuration 100, wherein electronic devices communicate via a network for purposes of exchanging content and other data. As shown, multiple computing devices (Client device 105, client device 115 and videoconference system 120) can be connected to communication network 110 and be configured to communicate with each other through use of communication network 110. Communication network 110 can be any type of network, including a local area network (“LAN”), such as an intranet, a wide area network (“WAN”), such as the internet, or any combination thereof. Further, communication network 110 can be a public network, a private network, or a combination thereof. Communication network 110 can also be implemented using any number of communications links associated with one or more service providers, including one or more wired communication links, one or more wireless communication links, or any combination thereof. Additionally, communication network 110 can be configured to support the transmission of data formatted using any number of protocols.

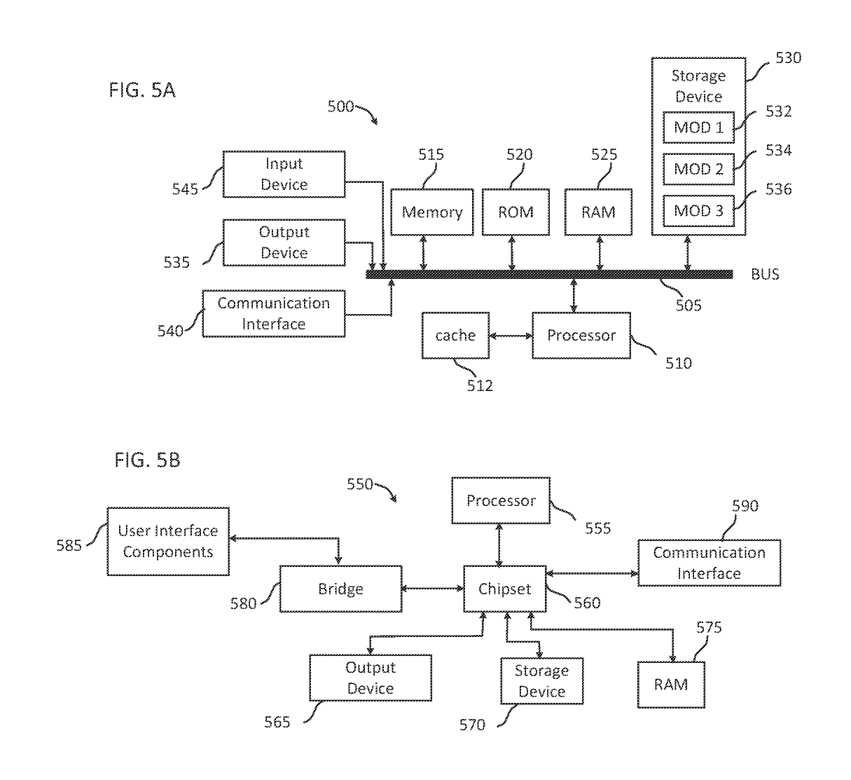

Multiple computing devices can be connected to communication network 110. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 500 of FIGS. 5A and 5B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

In system 100, meeting participants can interact with videoconference system 120 through client devices 105 and 115 connected to communication network 110 by direct and/or indirect communication. Although system 100 includes only two client devices 105, 115, this is only for ease of explanation and is not meant to be limiting. One skilled in the art would appreciate that system 100 can include any number of client devices and that videoconference system 120 can concurrently accept connections from and interact with multiple client devices. Videoconference system 120 can also support connections from a variety of different types of client devices, such as desktop computers; mobile computers; mobile communications devices, e.g. mobile phones, smart phones, tablets; smart televisions; set-top boxes; and/or any other network enabled computing devices. Client devices 105 and 115 can be of varying type, capabilities, operating systems, etc.

A meeting participant can interact with videoconference system 120 via a client-side application installed on client devices 105 and 115. In some embodiments, the client-side application can include a videoconference system specific component. For example, the component can be a stand-alone application, one or more application plug-ins, and/or a browser extension. However, the meeting participant can also interact with videoconference system 120 via a third-party application, such as a web browser, that resides on client devices 105 and 115 and is configured to communicate with videoconference system 120. In either case, the client-side application can present a user interface (UI) for the user to interact with videoconference system 120. For example, the user can interact with the videoconference system 120 via a client-side application integrated with the file system or via a webpage displayed using a web browser application.

Videoconference system 120 can be configured to facilitate and manage videoconference meetings between various client device. For example, videoconference system 120 can facilitate a videoconference between client device 105 and client device 115, where a meeting participant at client device 105 can send and receive audio and/or video with a meeting participant at client device 115.

To accomplish this, videoconference system 120 can include videoconference management module 125 configured to manage a videoconference between multiple client device, including initiating the videoconference, identifying the client devices included in the videoconference and sending and receiving videoconference data to and from the various client devices engaged in the videoconference. For example, to manage a videoconference between meeting participants at client device 105 and client device 115, videoconference management module 125 can receive videoconference data, including audio data, video data, etc., from client device 105, and transmit the received videoconference data to client device 115, where it can be presented by client device 115. Likewise, videoconference management module 125 can receive video conference data from client device 115 and transfer the received videoconference data to client device 103, where it can be presented by client device 105. This can allow meeting participants at client device 105 and client device 115 to receive and share data, including audio and/or video data, thereby enabling the meeting participants to have a real time meeting although they may be in different locations.

In some embodiments, videoconference system 120 can be configured to enable a meeting participant to notify the other meeting participants in the videoconference that the meeting participant will be stepping away from the videoconference and/or inattentive for a period of time. For example, a meeting participant may need to walk away from his computing device and/or concentrate on another matter for a short period of time. Videoconference system 120 can enable the meeting participant to notify the other meeting participants that the meeting participant will be away.

To accomplish this, videoconference system 120 can include alert module 130. Alert module 130 can be configured to provide meeting participants of a videoconference with a user interface element enabling the meeting participant to indicate that the meeting participant will be away from the teleconference, i.e. away from their computing device and/or concentrating on a different task. For example, away module 130 can transmit data to the meeting participants client devices causing the client device to present a user interface element such as a button that can be selected to indicate that the meeting participant will be away from the teleconference.

A meeting participant on client device 105 can select the user interface element, causing client device 105 to transmit an away notification to videoconference system 120. The away notification can indicate that the meeting participant at client device 105 will be away from the ongoing videoconference. In some embodiments, the away notification can include metadata identifying the meeting participant and/or the videoconference. For example, the away notification can include a user identifier that uniquely identifies the meeting participant. Likewise, the away notification can include a videoconference identifier that uniquely identifies the videoconference.

Upon receiving an away notification, alert module 130 can be configured to notify the other meeting participants of the videoconference that the away meeting participant will be away from the teleconference. Alert module 130 can identify the other meeting participants using the videoconference identifier received with the away message. Videoconference system 120 can include videoconference database 135 that maintains date relating to a videoconference. For example, videoconference database 135 can maintain data identifying the meeting participants of a videoconference, contact information for the meeting participants, client devices utilized by the meeting participants, etc.

Upon identifying the other meeting participants, alert module 130 can notify the other meeting participants that the away meeting participant will be away from the videoconference. For example, alert module 130 can cause an indicator to be presented to the other meeting participant that identifies the away meeting participant as having a status of away from the teleconference. To accomplish this, alert module 130 can transmit data to client device 115 that identifies the away meeting participant and indicates that the away meeting participant is away from the videoconference. Client device 115 can then present an indicator notifying the meeting participant that the away meeting participant is away from the videoconference.

Alert module 130 can be configured to enable an away meeting participant to notify the other meeting participants that the away meeting participant has rejoined the video conference, i.e. is away meeting participant is back at their computing device and/or paying attention to the videoconference. In some embodiments, the alert module 130 can provide an away meeting participant with a user interface element, such as a button, that, when selected, notifies the other meeting participants that the away meeting participant has rejoined the videoconference. For example, away module 130 can transmit data to a client device 105 that causes client device 105 to present the user interface element such as a button, which the away meeting participant can select to notify the other meeting participants that the away meeting participant has rejoined the teleconference.

An away meeting participant on client device 105 can select the user interface element, causing a return notification to be transmitted to videoconference server 120. The return notification can identify the returning meeting participant as well as the videoconference. Upon receiving the return notification, alert module 130 can identify the other meeting participants and notify them that the returning meeting participant has rejoined the videoconference. For example, alert module 130 can transmit data to client device 115 that identifies the returning meeting participant and indicates that the returning meeting participant has rejoined the videoconference. Client device 115 can then present an indicator notifying the meeting participant that the returning meeting participant has rejoined the videoconference.

In some embodiments, alert module 130 can be configured to enable meeting participants to alert an away meeting participant to rejoin a videoconference. For example, a discussion during the videoconference may require input from an away meeting participant. The other meeting participants can send the away meeting participant an alert to rejoin the videoconference. To accomplish this, alert module 130 can provide the other meeting participants with a user interface element enabling the other meeting participants to alert the away meeting participant to rejoin the videoconference. Alert module 130 can transmit data to client device 115 that causes client device 115 to present the user interface element. When selected by a meeting participant, the user interface element can cause client device 115 to transmit an alert request to videoconference system 120 requesting that an away meeting participant be alerted to rejoin the videoconference. The alert request can identify the away meeting participant. Upon receiving an alert request, alert module 130 can transmit an alert message to the away meeting participant alerting the away meeting participant to rejoin the videoconference.

An alert message can be sent in one or more of variety ways and using a variety of contact methods. In some embodiments, the alert message can be a message presented at the away meeting participant's client device. For example, away module 130 can transmit data to client device 105 to alert an away meeting participant using client device 105 to rejoin the videoconference. This can include presenting a message alert, sound alert, video alert, etc.

In some embodiments, alert module 130 can transmit the alert message to the away meeting participant via e-mail, text message, instant message, phone, or any other available contact method. Alert module 130 can access contact information for the meeting participant in videoconference database 135 and use the contact information to transmit the alert message.

In some embodiments, alert module 130 can transmit the alert message to the away meeting participant using a preferred contact method provided by the receiving user. For example, alert module 130 can enable meeting participants to select a preferred contact method that should be used to send the meeting participant an alert message. Alert module 130 can store the preferred contact method in videoconference database 135 where it can be accessed later to determine the preferred contact method for the meeting participant.

In some embodiments, alert module 130 can enable a meeting participant to set their preferred contact method at any time. For example, a meeting participant can select their preferred contact method as part of their user preferences that are then stored in videoconference database 135. In some embodiments, alert module 130 can prompt a meeting participant to select a preferred contact method when the meeting participant selects to notify the other meeting participants that the meeting participant will be away from the videoconference. For example, alert module 130 can provide the meeting participant with an away interface that enables the meeting participant to select a preferred contact method at the time the meeting participant selects to notify the other meeting participants that the meeting participant will be away from the videoconference. An entered preferred contact method can be transmitted to videoconference system 120 and stored in videoconference database 135.

In some embodiments, alert module 130 can be configured to transmit a follow up alert message to an away meeting recipient if the meeting recipient does not rejoin the videoconference after receiving the first alert message. Alert module 130 can transmit the follow up alert message if the away meeting participant hasn't rejoined the videoconference within a specified amount of time after the first alert message was transmitted to the away meeting participant.

Alert module 130 can determine if the away meeting participant has rejoined the videoconference upon receiving a return notification from the meeting participant. If alert module 130 determines that the predetermined amount of time has elapsed without the meeting participant rejoining the videoconference, alert module 130 can transmit the follow up alert message to the meeting participant. In some embodiments, alert module 130 can transmit the follow up alert message using the same contact method used to transmit the first alert message. Alternatively, in some embodiments, alert module 130 can transmit the follow up alert message using contact methods that were not used to send the first alert message.

In some embodiments, alert module 130 can enable a meeting participant to select to receive an alert message upon a specified alert trigger occurring. This can allow a meeting participant that does not need to participate until a specified portion of a meeting to be set an alert trigger that will alert the meeting participant to rejoin the videoconference at the specified portion of the meeting, thereby allowing the meeting participant to perform other tasks when he/she is not needed.

To accomplish this, alert module 130 can provide meeting participants with an alert interface that enables a meeting participant to set one or more alert triggers. Upon receiving data describing an alert trigger from a meeting participant, alert module 130 can store the data in videoconference database 135. Alert module 130 can further monitor the videoconference to determine whether the alert trigger has occurred, upon which alert module 130 can transmit the meeting participant an alert message to rejoin the video conference.

In some embodiments, an alert trigger can be set based on time. For example, a meeting participant can select to receive an alert notification at a specified time and/or after a specified amount of time has elapsed. Alert module 130 can monitor the time to determine when the alert trigger has been triggered, and then transmit the meeting participant an alert message to rejoin the videoconference.

In some embodiments, an alert trigger can be set based on use of a specified term during the videoconference. For example, a meeting participant can choose to receive an alert message when the meeting participants name is used, a specified product name is used, the meeting participants e-mail address is used, etc. The alert interface can be configured to allow the meeting participant to specify one or more terms as an alert trigger. Alert module 130 can monitor the videoconference for use of the specified term and, upon determining that the term was used, transmit an alert notification to the meeting participant.

In some embodiments, alert module 130 can be configured to monitor speech communication during the videoconference to determine whether a specified term has been used. For example, alert module 130 can analyze videoconference data received from the client devices to determine whether any meeting participant spoke the specified term.

In some embodiments, alert module 130 can be configured to monitor text communication during the videoconference to determine whether a specified term has been used. For example, alert module 130 can analyze videoconference data received from the client devices to determine whether any meeting participant typed the specified term in a written message.

In some embodiments, an alert trigger can be set based on a specified file being presented during the videoconference. For example, a meeting participant scheduled to present a slide presentation can choose to receive an alert notification when the slide presentation has been opened. Likewise, a meeting participant scheduled to present a portion of a slide presentation can choose to receive an alert notification when a specified slide of the presentation has been accessed. As another example, a meeting participant can choose to receive an alert message when a video is opened or, alternatively, a specified point in the video is played.

The alert interface can be configured to enable a meeting participant to select a presentation of a specified file and/or a specified point of a file as an alert trigger. Alert module 130 can monitor the video conference data to determine whether the specified file or specified portion of the file has been presented, upon which an alert message can be sent to the meeting participant.

In some embodiments, alert module 130 can be configured to enable a user to select to delay transmission of an alert message for a specified amount of time after the alert trigger has been triggered. For example, the alert interface can enable a meeting participant to specify a notification delay time to wait after an alert trigger has been triggered before the alert notification is transmitted to the meeting participant. Upon detecting that an alert trigger has been triggered, alert module 130 can wait for the specified notification delay time, after which alert module 130 can transmit the alert notification to the meeting participant.

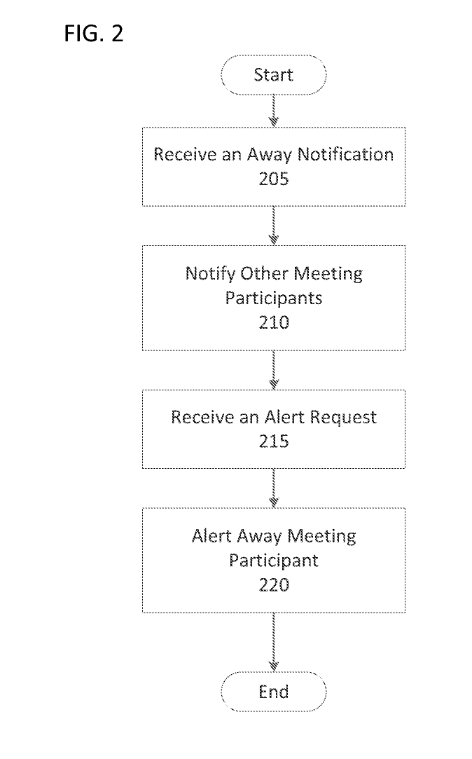

FIG. 2 shows an example method embodiment of alerting an away meeting participant to rejoin a videoconference. As shown, the method begins at block 205 where an away notification is received from a meeting participant. An away notification can indicate that a meeting participant of a video conference will be away from the videoconference.

Upon receiving the away notification, the method continues to block 210 where other meeting participants of the videoconference are notified that the meeting participant will be away from the videoconference. For example, the other meeting participants can be presented with a indication that the meeting participants status is currently away from the videoconference.

At block 215, an alert request is received from one of the other meeting participants. An alert request can be a request to alert the away meeting participant to rejoin the videoconference.

At block 220, an alert message is transmitted to the away meeting participant. The alert message can alert the away meeting participant to rejoin the videoconference. For example, the alert message can be a text, video, phone, instant message, email, etc., message that notifies the away meeting participant that another meeting participant has requested that the away meeting participant rejoin the videoconference.

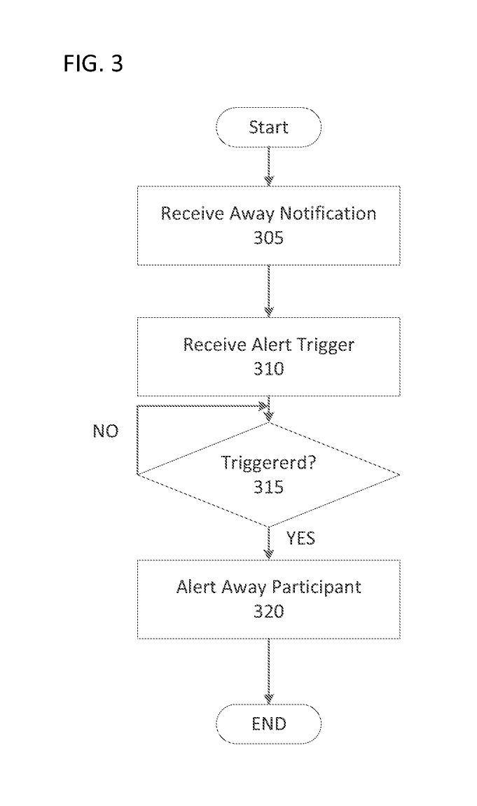

FIG. 3 shown an example method embodiment of alerting an away meeting participant to rejoin a videoconference upon an alert trigger occurring. As shown, the method begins at block 305 where an away notification is received from a meeting participant. An away notification can indicate that the meeting participant of a video conference will be away from the videoconference.

At block 310 an alert trigger is received from the meeting participant. An alert trigger can be data describing a specified condition that, upon which, the meeting participant would like to be notified to rejoin the videoconference. For example, the alert trigger can be a specified time, a specified amount of time elapsing, a specified term or terms being used during the videoconference, a specified file or portion of a file being accessed, etc.

While block 305 and 310 are presented as two separate blocks, in some embodiments the two blocks can occur concurrently or substantially concurrently. For example, the away notification and alert trigger can be received in the same message.

At block 315 it is determined whether the alert trigger has been triggered. For example, a clock component can be monitored to determine whether a time based alert trigger has been triggered. Likewise, videoconference data can be monitored to determine whether a term or file based alert trigger has been triggered. For example, speech and text used during the video conference can be monitored to determine whether a term based alert trigger has been triggered.

If at block 315 it is determined that an alert trigger has been triggered, the method continues to block 320 where an alert message is transmitted to the meeting participant. The alert message can alert the meeting participant that the alert trigger has been triggered and the meeting participant should rejoin the videoconference.

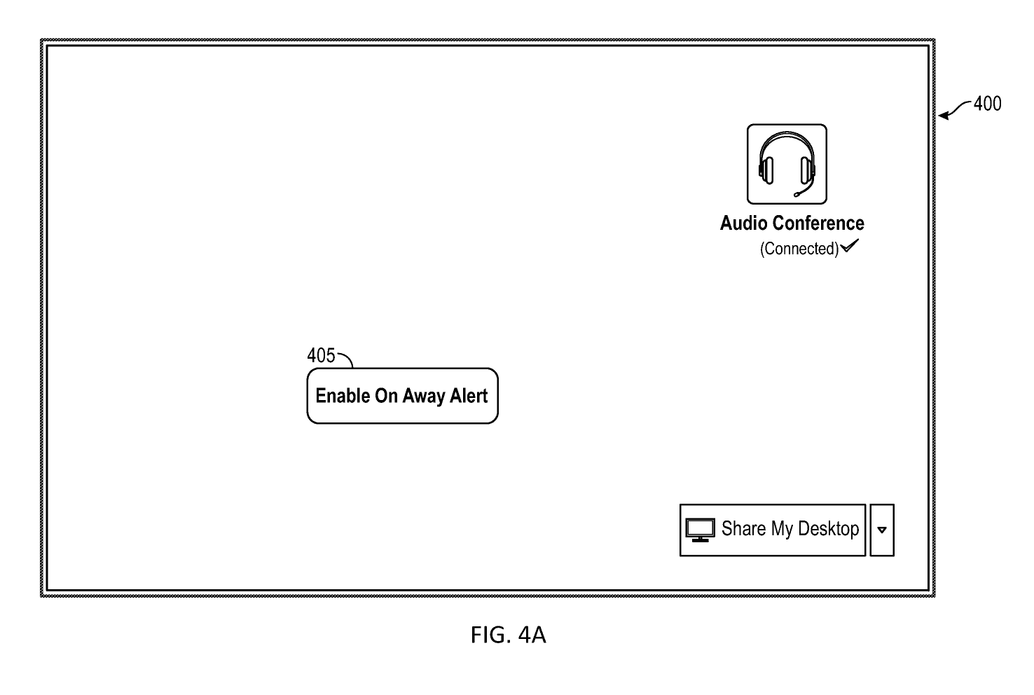

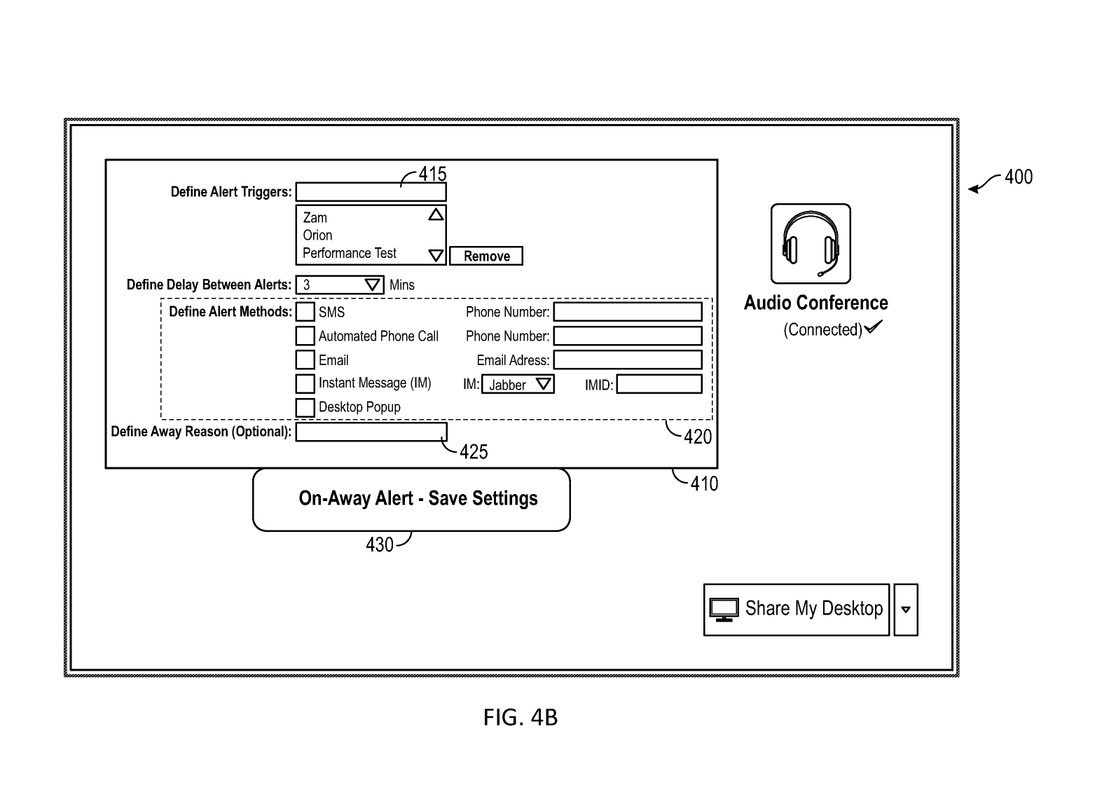

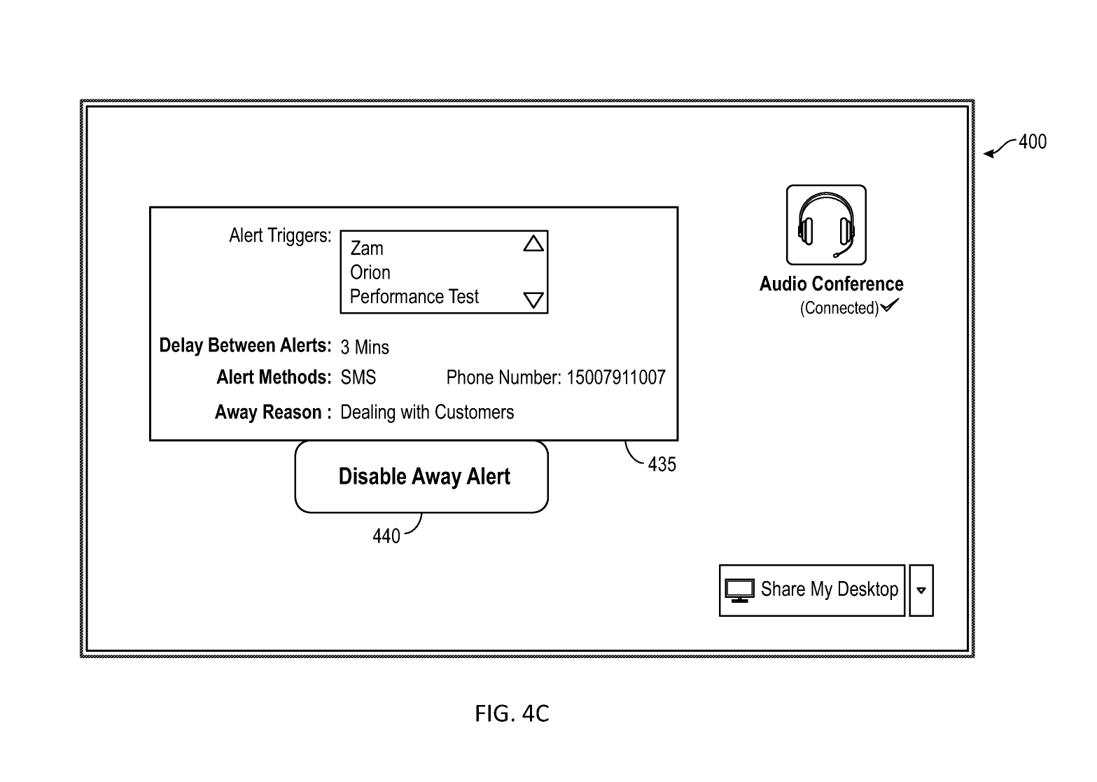

FIGS. 4A-4C show example embodiments of a videoconference interface 400 presented to a meeting participant. As shown in FIG. 4A, a meeting participant can be presented with user interface element 405 that enables the meeting participant to notify the other meeting participants that the meeting participant will be away from the videoconference. The meeting participant can select user interface element 405 to change the meeting participant's status to away, thereby alerting the other meeting participants that the meeting participant will be away from the videoconference.

FIG. 4B shows an example presentation of the videoconference interface 400 resulting from the meeting participant selecting user interface element 405. As shown, alert interface 410 is presented to the meeting participant. Alert interface 410 can enable the meeting participant to select various alert settings. For example, alert interface 410 can include alert interface element 415 that enables the meeting participant to select one or more alert triggers.

Further alert interface 410 can include interface element area 420 that enables the meeting participant to select one or more preferred contact methods, and enter contact details for the various contact methods. For example, the meeting participant can choose to be alerted via SMS, automated phone call, email, instant message or desktop popup.

Alert interface 410 can also include interface element 425 that enables the meeting participant to enter a reason why the meeting participant will be away from the videoconference. The entered reason can then be presented to the other meeting participants of the videoconference.

Videoconference interface 400 can also include user interface element 430 that can be configured to enable a meeting participant to save their entered alert settings and alert the other meeting participants that the meeting participant will be away from the videoconference. For example, upon selection of user interface element 430, an away notification can be transmitted to notify the other meeting participants that the meeting participant will be away from the videoconference.

FIG. 4C shows an example presentation of the videoconference interface 400 resulting from the meeting participant selecting user interface element 430. As shown, the meeting participant can be presented with alert interface 435 that presents the alert setting selected by the meeting participant. This can include the alert triggers selected by the meeting participant as well as their preferred contact method and reason for being away. videoconference interface 400 can further include user interface element 440 that is configured to enable the meeting participant to disable the selected alert triggers. For example, upon selection of user interface element 440, the meeting participant will no longer receive alert messages upon the specified alert triggers being triggered.

Further, in some embodiments, selection of user interface element 440 can alert the other meeting participants that the away meeting participant has rejoined the videoconference. For example, upon selection of user interface element 440, a return message can be transmitted to the other meeting participants that alerts the other meeting participants that the away meeting participant has rejoined the videoconference and therefore his/her status is no longer away.

FIG. 5A, and FIG. 5B show example possible system embodiments. The more appropriate embodiment will be apparent to those of ordinary skill in the art when practicing the present technology. Persons of ordinary skill in the art will also readily appreciate that other system embodiments are possible.

FIG. 5A shows a conventional system bus computing system architecture 500 wherein the components of the system are in electrical communication with each other using a bus 505. Example system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B shows a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that example systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, by a processor, a first away notification indicating that a first participant of a videoconference will be away from the videoconference;
notifying, by the processor, a second participant of the videoconference that the first participant will be away from the videoconference;
receiving, by the processor, from the second participant, an alert request requesting that the first participant be alerted to rejoin the videoconference; and
transmitting, by the processor, a first alert message to the first participant, wherein the first alert message alerts the first participant to rejoin the videoconference.

2. The method of claim 1, further comprising:
receiving a preferred contact method for the first participant, wherein the alert message is transmitted to the first participant via the first contact method.

3. The method of claim 1, further comprising:
determining that a specified amount of time has elapsed since the first alert message was transmitted to the first participant and the first participant has not yet rejoined the videoconference; and
transmitting, a second alert message to the first participant, wherein the second alert message alerts the first participant to rejoin the videoconference.

4. The method of claim 1, further comprising:
receiving, from the first participant, a selected alert trigger upon which the first participant would like to be alerted to rejoin the videoconference;
determining that the selected alert trigger has occurred; and
transmitting, to the first participant, a third alert message, wherein the third alert message alerts the third participant to rejoin the videoconference.

5. The method of claim 4, wherein determining that the selected trigger has occurred comprises:
monitoring speech during the videoconference for use of a first term, wherein the selected alert trigger is use of the first term during the videoconference; and
determining, from the monitoring, that the first term was used during the videoconference.

6. The method of claim 4, wherein determining that the selected trigger has occurred comprises:
monitoring text communication during the videoconference for use of a second term, wherein the selected alert trigger is use of the second term during the videoconference; and
determining, from the monitoring, that the first term was used during the videoconference.

7. The method of claim 4, further comprising:
receiving from the first participant, a notification delay time associated with the selected alert trigger; and
upon a determination that the selected trigger has occurred, determining that the notification delay time has elapsed, wherein the transmitting the third alert message occurs upon a determination that the notification delay time has elapsed.

8. A system comprising:
a processor; and
a memory containing instructions that, when executed, cause the processor to:
receive a first away notification indicating that a first participant of a videoconference will be away from the videoconference;
receive, from the first participant, a selected alert trigger upon which the first participant would like to be alerted to rejoin the videoconference;
determine that the selected alert trigger has occurred; and
transmit a first alert message to the first participant, wherein the first alert message alerts the first participant to rejoin the videoconference.

9. The system of claim 8, wherein the instructions further cause the processor to:
receive a preferred contact method for the first participant, wherein the alert message is transmitted to the first participant via the first contact method.

10. The system of claim 8, wherein the instructions further cause the processor to:
determine that a specified amount of time has elapsed since the first alert message was transmitted to the first participant and the first participant has not yet rejoined the videoconference; and
transmit a second alert message to the first participant, wherein the second alert message alerts the first participant to rejoin the videoconference.

11. The system of claim 8, wherein determining that the selected trigger has occurred comprises:
monitoring speech during the videoconference for use of a first term, wherein the selected alert trigger is use of the first term during the videoconference; and
determining, from the monitoring, that the first term was used during the videoconference.

12. The system of claim 8, wherein determining that the selected trigger has occurred comprises:
monitoring text communication during the videoconference for use of a second term, wherein the selected alert trigger is use of the second term during the videoconference; and
determining, from the monitoring, that the first term was used during the videoconference.

13. The system of claim 11, wherein the instructions further cause the processor to:
receive from the first participant, a notification delay time associated with the selected alert trigger; and
upon a determination that the selected trigger has occurred, determine that the notification delay time has elapsed, wherein the transmitting the first alert message occurs upon a determination that the notification delay time has elapsed.

14. The system of claim 8, wherein the instructions further cause the processor to:
notify a second participant of the videoconference that the first participant will be away from the videoconference;
receive from the second participant, an alert request requesting that the first participant be alerted to rejoin the videoconference; and
transmit a third alert message to the first participant, wherein the first alert message alerts the first participant to rejoin the videoconference.

15. A non-transitory computer-readable medium containing instructions that, when executed by a computing device, cause the computing device to:
receive a first away notification indicating that a first participant of a videoconference will be away from the videoconference;
receive, from the first participant, a selected alert trigger upon which the first participant would like to be alerted to rejoin the videoconference;
determine that the selected alert trigger has occurred; and
transmit a first alert message to the first participant, wherein the first alert message alerts the first participant to rejoin the videoconference.

16. The non-transitory computer-readable medium of claim 15, wherein the instructions further cause the computing device to:
receive a preferred contact method for the first participant, wherein the alert message is transmitted to the first participant via the first contact method.

17. The non-transitory computer-readable medium of claim 15, wherein the instructions further cause the computing device to:
determine that a specified amount of time has elapsed since the first alert message was transmitted to the first participant and the first participant has not yet rejoined the videoconference; and
transmit a second alert message to the first participant, wherein the second alert message alerts the first participant to rejoin the videoconference.

18. The non-transitory computer-readable medium of claim 15, wherein determining that the selected trigger has occurred comprises:
monitoring speech during the videoconference for use of a first term, wherein the selected alert trigger is use of the first term during the videoconference; and
determining, from the monitoring, that the first term was used during the videoconference.

19. The non-transitory computer-readable medium of claim 15, wherein determining that the selected trigger has occurred comprises:
monitoring text communication during the videoconference for use of a second term, wherein the selected alert trigger is use of the second term during the videoconference; and
determining, from the monitoring, that the first term was used during the videoconference.

20. The non-transitory computer-readable medium of claim 18, wherein the instructions further cause the computing device to:
receive from the first participant, a notification delay time associated with the selected alert trigger; and
upon a determination that the selected trigger has occurred, determine that the notification delay time has elapsed, wherein the transmitting the first alert message occurs upon a determination that the notification delay time has elapsed.
